(19) United States
(12) Patent Application Publication
(10) Pub. No.: US 2026/0033534 A1
(43) Pub. Date: Feb. 5, 2026

(54) AN AEROSOL-GENERATING ARTICLE COMPRISING A PIEZOELECTRIC COMPONENT

(71) Applicant: Philip Morris Products S.A., Neuchatel (CH)

(72) Inventors: Leander DITTMANN, Crissier (CH); Hrayr HOVSEPYAN, Yerevan (AM); Rafael HOVHANNISYAN, Yerevan (AM); Mkhitar HOVHANNISYAN, Yerevan (AM)

(73) Assignee: Philip Morris Products S.A., Neuchatel (CH)

(21) Appl. No.: 19/099,992

(22) PCT Filed: Aug. 11, 2023
(86) PCT No.: PCT/EP2023/072310

§ 371 Date: Jan. 30, 2025

(30) Foreign Application Priority Data
Aug. 17, 2022 (AM) AM20220085

(51) Int. Cl. A24F 40/05; A24F 40/10; A24F 40/42; A24F 40/44; B05B 17/06

(52) U.S. Cl. CPC A24F 40/05; A24F 40/10; A24F 40/42; A24F 40/44; B05B 17/0607

(57) ABSTRACT

An aerosol-generating article is provided, including: an atomiser configured to atomise a liquid aerosol-forming substrate to generate an aerosol, the atomiser including: a piezoelectric component including: an actuator, and a porous element, the actuator being arranged to vibrate the porous element to generate an aerosol, and the porous element being a freeze-cast porous element. An aerosol-generating system including an aerosol-generating device and the aerosol-generating article is also provided.

The present invention relates to an aerosol-generating article. In particular, the present invention relates to an aerosol-generating article that can be used to generate an aerosol by non-thermal vaporisation.

One type of aerosol-generating system is an electrically operated smoking system. Handheld, electrically operated smoking systems consisting of an aerosol-generating device comprising a battery and control electronics, and an aerosol-generating article comprising a supply of aerosol forming substrate and an electrically operated vaporiser, are known. An aerosol-generating article, such as a cartridge, comprising both a supply of aerosol-forming substrate and a vaporiser is sometimes referred to as a “cartomiser”. Such an aerosol-generating article may comprise not only the supply of aerosol-forming substrate and an electrically operated vaporiser, but also a mouthpiece, which the user sucks on in use to draw aerosol into their mouth

A vaporiser may be configured to vaporise the aerosol-forming substrate by various methods, which can be divided into either thermal vaporisation or non-thermal vaporisation.

Thermal vaporisation involves heating the aerosol-forming substrate until the aerosol-forming substrate vaporises. Vaporisers for thermally vaporising an aerosol-forming substrate typically comprise a coil of heater wire wound around an elongate wick soaked in liquid aerosol-forming substrate.

Non-thermal vaporisation generates an aerosol without heat. One example of non-thermal vaporisation is ultrasonic nebulisation, which may involve forcing the aerosol-forming substrate through a porous membrane that is being vibrated by a piezoelectric actuator.

Arrangements for non-thermal vaporisation can be difficult to manufacture. For example, a typical method of manufacture involves casting a membrane from a metal, drilling small holes in the membrane to form a porous membrane, and attaching the porous membrane to a piezoelectric actuator.

It would be desirable to provide an aerosol-generating article that is suitable for non-thermal vaporisation of an aerosol-forming substrate and that is simple to manufacture.

There is provided an aerosol-generating article comprising: a piezoelectric component, the piezoelectric component comprising: an atomiser for atomising a liquid aerosol-forming substrate to generate an aerosol, the atomiser comprising: an actuator; and a porous element, wherein the actuator is arranged to vibrate the porous element to generate an aerosol, and wherein the porous element is a freeze-cast porous element.

There is also provided an aerosol-generating article. The aerosol-generating article may comprise an atomiser for atomising a liquid aerosol-forming substrate to generate an aerosol. The atomiser may comprise a piezoelectric component. The piezoelectric component may comprise an actuator. The piezoelectric component may comprise a porous element. The actuator may be arranged to vibrate the porous element to generate an aerosol. The porous element is a freeze-cast porous element.

There is also provided an aerosol-generating system comprising: an aerosol-generating device; and an aerosol-generating article, the aerosol-generating article comprising: an atomiser for atomising a liquid aerosol-forming substrate to generate an aerosol, the atomiser comprising: a piezoelectric component, the piezoelectric component comprising: an actuator; and a porous element, wherein the porous element is a freeze-cast porous element.

There is also provided an aerosol-generating system. The aerosol-generating system may comprise an aerosol-generating device and an aerosol-generating article. The aerosol-generating article may comprise an atomiser for atomising a liquid aerosol-forming substrate to generate an aerosol. The atomiser may comprise a piezoelectric component. The piezoelectric component may comprise an actuator. The piezoelectric component may comprise a porous element. The actuator may be arranged to vibrate the porous element to generate an aerosol. The porous element is a freeze-cast porous element.

The pores in a porous element are typically formed by drilling. Advantageously, forming the porous element by using freeze-casting may allow for the pores within the porous element to be formed as the porous element itself is formed. As a result, there may be provided an easier and more straightforward manufacturing process compared to the typical manufacturing process because the additional step of drilling holes in the porous element is eliminated.

Furthermore, using freeze-casting to form the pores may allow for smaller pores to be formed that are possible by traditional drilling.

As used herein, the term “aerosol-forming substrate” refers to a substrate capable of releasing volatile compounds that can form an aerosol. Volatile compounds may be released by heating the aerosol-forming substrate, or through non-thermal means.

As used herein, the term “porous” means formed from a material that has a plurality of openings and that is permeable to a liquid aerosol-forming substrate and allows a liquid aerosol-forming substrate to migrate through it by means of the openings.

As used herein, the term “pores” refers to openings in a porous material.

As used herein, the term “porous element” refers to a component of the aerosol-generating article that has a plurality of pores.

As used herein, the term “freeze-cast porous element” is a porous element that is formed by the method of freeze-casting.

The aerosol-generating article may be a cartridge.

The aerosol-generating article may comprise a housing. The housing may be a rigid housing. The housing may comprise a liquid storage portion. The housing may define a liquid storage portion. The liquid storage portion may hold a quantity of liquid aerosol-forming substrate.

The liquid aerosol-forming substrate may be adsorbed or otherwise loaded onto a carrier or support. The carrier may comprise carrier material. The carrier material may be made from any suitable absorbent plug or body, for example, a foamed metal or plastics material, polypropylene, terylene, nylon fibres or ceramic.

The aerosol-generating article may comprise a transport body. The transport body may be suitable for conveying aerosol-forming substrate to the piezoelectric component. The transport body may comprise a porous material. The transport body may comprise a first portion and a second portion. The first portion of the transport body may extend into the reservoir. The second portion of the transport body may be adjacent the piezoelectric component.

The liquid storage portion may comprise an opening. The porous element may extend across the opening of the liquid storage portion. The porous element may extend fully across the opening of the liquid storage portion. Alternatively, in some examples, the porous element may extend partially across the opening of the liquid storage portion.

The actuator may comprise one or more actuators. The actuator may comprise a plurality of actuators.

The actuator may be any type of actuator for exciting vibrations in the porous element.

The actuator may comprise a piezo actuator. The actuator may comprise one or more piezo actuators. The actuator may comprise a plurality of piezo actuators.

By piezo actuator it is meant piezo-electric actuator. Piezo actuators are preferred because they provide an energy-efficient and lightweight means of inducing vibration of the porous element, possessing a high energy conversion efficiency from electric to acoustic/mechanical power. Further, piezo actuators are available in a wide variety of materials and shapes. For a piezo actuator, inputting an electrical driving signal to the piezo actuator would result in a mechanical output in the form of a vibration signal.

Tuning and adjustment of the electrical driving signal being input to the piezo actuator may result in corresponding changes in the output vibration signal, thereby enabling the actuator to activate different vibration modes of the porous element.

Other types of actuator or transducer may be employed. For example, the actuator may comprise one or more magnetostrictive transducers. The actuator may comprise one or more electrostrictive transducers. The actuator may comprise one or more piezomagnetic transducers.

Combinations of different types of actuator or transducer are possible, for example in layered structures or in parallel.

The actuator may be arranged at any suitable location with respect to the porous element. The actuator may be arranged to transmit vibrations to the porous element at an inlet side or the outlet side of the porous element. The actuator may be arranged to transmit vibrations to the porous element at the inlet side. The actuator may be arranged to transmit vibrations to the porous element at the outlet side.

The actuator may be arranged to vibrate the porous element in any suitable direction. The actuator may be arranged to vibrate the porous element in a thickness direction. As used herein, ‘thickness direction’ means a direction substantially parallel to the thickness of the porous element. This may facilitate deformation in the porous element that encourages movement of liquid aerosol-forming substrate through passages in the porous element.

The actuator may comprise one or more actuating elements. The one or more actuating elements may be any suitable shape. The one or more actuating elements may be substantially circular or elliptical. The one or more actuating elements may be substantially triangular, square or any regular or irregular shape. The one or more actuating elements may be annular. The one or more actuating elements may substantially circumscribe the plurality of passages of the porous element. By circumscribing the plurality of passages in the porous element, the one or more actuating elements may not cover an open end of the passages. The one or more actuating elements may be substantially flat. The one or more actuating elements may have a thickness of between about 0.1 mm and 5.0 mm. The one or more actuating elements may be a substantially annular disc. The outer diameter of the annular disc may be between about 3 mm and about 60 mm and the inner diameter may be between about 2 mm and about 59 mm.

The actuator may be attached to one side of the porous element. An actuator may be attached both sides of the porous element.

The porous element may be formed by freeze-cast sintering. In other words, the porous element may be a freeze-cast sintered porous element.

The porous element may comprise a plurality of pores. In this way, the porous element is fluid permeable. The porous element may comprise a plurality of passages.

As used herein, the term “fluid permeable” with respect to the porous element means that the porous element allows a fluid, for example, a gas or a liquid, to pass through it. For example, the porous element may allow liquid aerosol-forming substrate to pass through its pores.

The porous element may be a porous membrane. The porous element may be a vibratable element.

The porous element may be a porous plate. The porous plate may be a perforated plate.

The porous element may be a thin sheet. As used herein, ‘thin’ denotes a body having a thickness that is substantially smaller than the other dimensions of the body, such as length, width or diameter. The porous element may have a thickness of between about 0.1 mm and about 4.0 mm. The porous element may have a longitudinal length or diameter of between about 3 mm and about 60 mm.

As used herein, the term ‘diameter’ denotes the maximum dimension in the transverse direction of parts or portions of parts of the aerosol-generating article.

The porous element may be any suitable shape. The porous element may be substantially circular or elliptical. The porous element may be substantially triangular or square or any regular or irregular shape. The porous element may be substantially flat. The porous element may be curved. The porous element may be dome shaped. The porous element may be a substantially square plate. The porous element may be a substantially circular or elliptical disc.

The porous element may comprise an inlet side and an opposing outlet side. Each pore or passage of the porous element may extend between the inlet side and the outlet side.

The porous element may comprise a plurality of pores or passages.

The average diameter of the plurality of pores may be less than or equal to 10 micrometres. The average diameter of the plurality of pores may be less than or equal to 15 micrometres. The average diameter of the plurality of pores may be less than or equal to 20 micrometres. The average diameter of the plurality of pores may be less than or equal to 25 micrometres. The average diameter of the plurality of pores may be less than or equal to 30 micrometres.

The average diameter of the plurality of pores may be at least 5 micrometres. The average diameter of the plurality of pores may be at least 10 micrometres.

The average diameter of the plurality of pores may be between 10 micrometres and 30 micrometres.

The porous element may have at least 50 percent of the plurality of pores with an average diameter of less than or equal to 10 micrometres. The porous element may have at least 55 percent of the plurality of pores with an average diameter of less than or equal to 10 micrometres. The porous element may have at least 60 percent of the plurality of pores with an average diameter of less than or equal to 10 micrometres. The porous element may have at least 65 percent of the plurality of pores with an average diameter of less than or equal to 10 micrometres. The porous element may have at least 70 percent of the plurality of pores with an average diameter of less than or equal to 10 micrometres. The porous element may have at least 75 percent of the plurality of pores with an average diameter of less than or equal to 10 micrometres.

The porous element may have at least 50 percent of the plurality of pores with an average diameter of less than or equal to 20 micrometres. The porous element may have at least 55 percent of the plurality of pores with an average diameter of less than or equal to 20 micrometres. The porous element may have at least 60 percent of the plurality of pores with an average diameter of less than or equal to 20 micrometres. The porous element may have at least 65 percent of the plurality of pores with an average diameter of less than or equal to 20 micrometres. The porous element may have at least 70 percent of the plurality of pores with an average diameter of less than or equal to 20 micrometres. The porous element may have at least 75 percent of the plurality of pores with an average diameter of less than or equal to 20 micrometres.

The porous element may have at least 50 percent of the plurality of pores with an average diameter of less than or equal to 30 micrometres. The porous element may have at least 55 percent of the plurality of pores with an average diameter of less than or equal to 30 micrometres. The porous element may have at least 60 percent of the plurality of pores with an average diameter of less than or equal to 30 micrometres. The porous element may have at least 65 percent of the plurality of pores with an average diameter of less than or equal to 30 micrometres. The porous element may have at least 70 percent of the plurality of pores with an average diameter of less than or equal to 30 micrometres. The porous element may have at least 75 percent of the plurality of pores with an average diameter of less than or equal to 30 micrometres.

The porous element may be prepared by a process comprising the steps of: preparing a slurry by mixing aluminium oxide with liquid camphene; heating the slurry to between 40 degrees Celsius and 50 degrees Celsius to form a warmed slurry; heating a mould to between 40 degrees Celsius and 50 degrees Celsius; pouring the warmed slurry into the mould; and placing the mould on a block of ice having a temperature of between minus 25 degrees Celsius and minus 30 degrees Celsius for a period of between 2 minutes and 15 minutes so that the slurry freezes and the temperature of the slurry decreases to between minus 2 degrees Celsius and minus 20 degrees Celsius.

The porous element may comprise a metal coating.

The metal coating may comprise nickel. The porous element may comprise a nickel coating. The metal coating may comprise platinum. The porous element may comprise a platinum coating. The metal coating may comprise titanium. The porous element may comprise a titanium coating. The metal coating may comprise silver. The porous element may comprise a silver coating. The metal coating may comprise gold. The porous element may comprise a gold coating.

The piezoelectric component may be assembled by attaching the one or more actuators to the porous element. The one or more actuators may be attached to the porous element by any suitable means, such as by use of an adhesive.

In one example, the porous element may be formed or grown directly on the one or more actuators.

The piezoelectric component may comprise a non-porous element. The non-porous element may be substantially fluid impermeable. As used herein, the term “fluid impermeable” with respect to the non-porous element means that the non-porous element does not allow a fluid, for example, a gas or a liquid, to pass through it.

The non-porous element may comprise a metal. The non-porous element may be ring-shaped. The non-porous element may be disc-shaped.

The piezoelectric component may comprise one or more porous elements attached to a non-porous element. The piezoelectric component may comprise a disc-shaped porous element attached to a centre of a ring-shaped non-porous element. The piezoelectric component may comprise a disc-shaped non-porous element attached to a centre of a ring-shaped porous element. The piezoelectric component may comprise a ring-shaped non-porous element attached to a centre of a ring-shaped porous element.

The piezoelectric component may comprise a ring-shaped non-porous element attached to a centre of a ring-shaped porous element, and a disc-shaped second porous element attached to a centre of the ring-shaped non-porous element.

The piezoelectric component may be assembled by attaching the one or more actuators to the non-porous element, and by then attaching the non-porous element to the porous element. The one or more actuators may be attached to the non-porous element by any suitable means, such as by use of an adhesive. The non-porous element may be attached to the porous element by any suitable means, such as by use of an adhesive.

Advantageously, providing a non-porous element may restrict or focus aerosol generation to the area in which the porous element is provided.

The piezoelectric component may comprise a plurality of porous elements. Each of the porous elements may be as described above.

The aerosol-forming substrate may be a liquid aerosol-forming substrate. The liquid aerosol-forming substrate is a liquid substrate, named also as e-liquid, capable of releasing volatile compounds that can form an aerosol. The volatile compounds may be released by heating the aerosol forming substrate.

The aerosol-forming substrate may comprise plant-based material.

The aerosol-forming substrate may comprise tobacco.

The aerosol-forming substrate may comprise a tobacco-containing material containing volatile tobacco flavour compounds, which are released from the aerosol-forming substrate upon vaporisation.

The aerosol-forming substrate may alternatively comprise a non-tobacco-containing material.

The aerosol-forming substrate may comprise homogenised plant-based material. The aerosol-forming substrate may comprise homogenised tobacco material.

The aerosol-forming substrate may comprise at least one aerosol-former. An aerosol-former is any suitable known compound or mixture of compounds that, in use, facilitates formation of a dense and stable aerosol. Suitable aerosol-formers are well known in the art and include, but are not limited to: polyhydric alcohols, such as triethylene glycol, 1,3-butanediol and glycerine; esters of polyhydric alcohols, such as glycerol mono-, di- or triacetate; and aliphatic esters of mono, di- or polycarboxylic acids, such as dimethyl dodecanedioate and dimethyl tetradecanedioate. Preferred aerosol formers are polyhydric alcohols or mixtures thereof, such as triethylene glycol, 1,3-butanediol and, most preferred, glycerine.

The aerosol-forming substrate may comprise other additives and ingredients, such as flavourants.

The aerosol-generating device may comprise a body. The body may be a rigid body. The body may be formed from any suitable material or combination of materials. Examples of suitable materials include, but are not limited to, metals, alloys, plastics or composite materials containing one or more of those materials. Preferably, the outer housing is light and non-brittle. The aerosol-generating device may include a mouthpiece. The body may be shaped to define the mouthpiece. Alternatively, the mouthpiece may be a separate component.

The aerosol-generating device may comprise a chamber for receiving the aerosol-generating article.

The aerosol-generating device may comprise a power source for supplying power to the actuator. The power source may comprise a battery. The battery may comprise a rechargeable battery.

The aerosol-generating device comprise a controller.

The controller may be configured to control operation of the aerosol-generating device.

When the aerosol-generating article is received within the aerosol-generating device, the aerosol-generating article may be inverted with respect to the orientation of the aerosol-generating device. Alternatively, when the aerosol-generating article is received within the aerosol-generating device, the aerosol-generating article may have the same orientation as the aerosol-generating device.

In use, a user may operate the aerosol-generating system by operating a switch or by drawing on a mouthpiece of the aerosol-generating device. Upon operation, the actuator may activated, exciting vibrations in the porous element. The vibrations in the porous element may deform the porous element and the pores within the porous element. Liquid aerosol-forming substrate may be received by the porous element at an inlet side. The deformation of the pores may draw the received, liquid aerosol-forming substrate into the pores and may eject aerosol droplets of the liquid aerosol-forming substrate from an opposing outlet side of the porous element, aerosolising the liquid aerosol-forming substrate

The invention will be further described with reference to the drawings of the accompanying Figures, wherein:

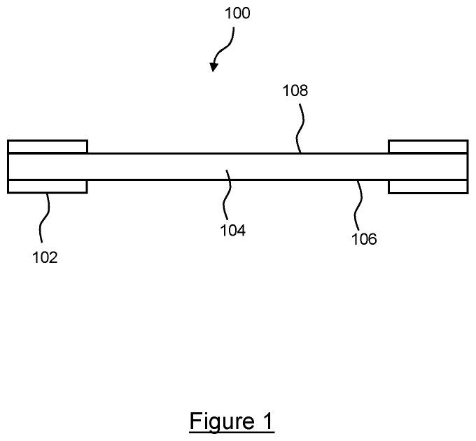

FIG. 1 shows schematically a cross-sectional view of an example of a piezoelectric component in accordance with an embodiment of the invention;

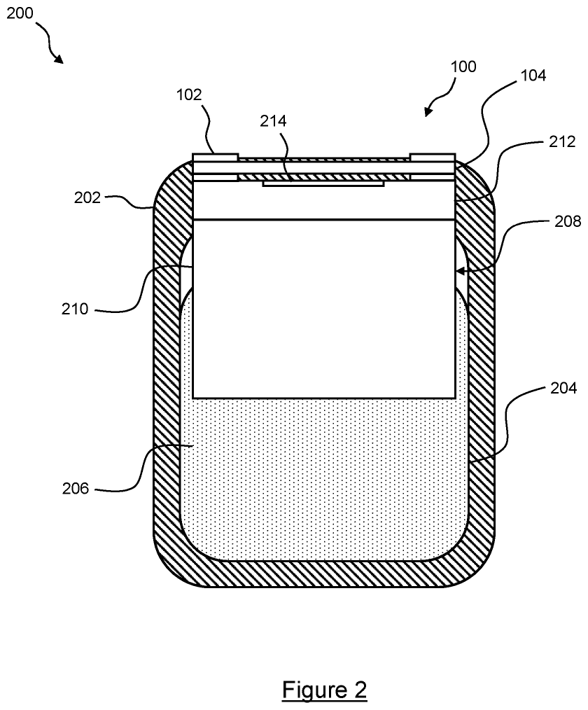

FIG. 2 shows schematically a cross-sectional view of an example of an aerosol-generating article in accordance with an embodiment of the invention, the aerosol-generating article including the piezoelectric component shown in FIG. 1;

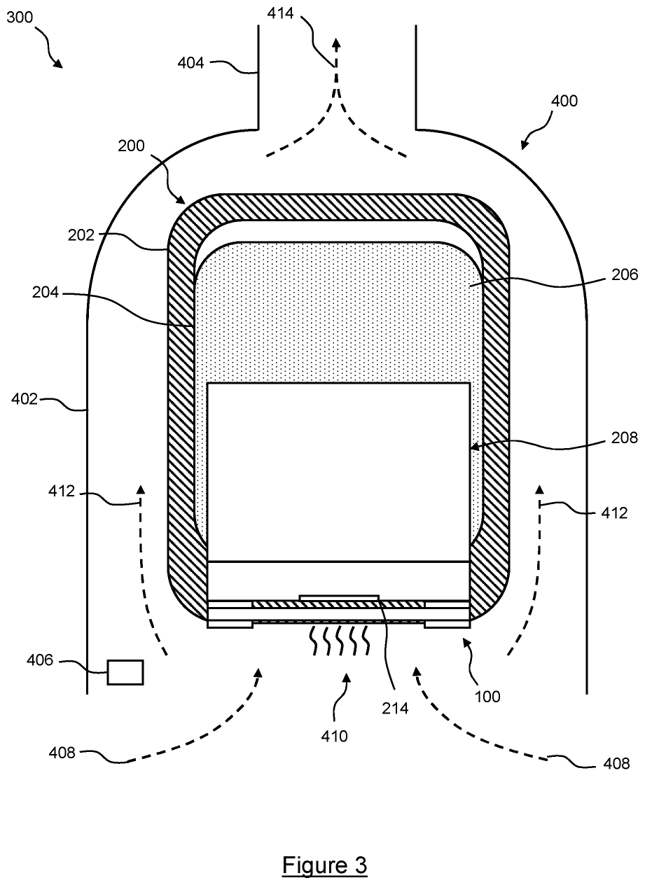

FIG. 3 shows schematically a cross-sectional view of an example of an aerosol-generating system in accordance with an embodiment of the invention, the aerosol-generating system includes an aerosol-generating device and the aerosol-generating article shown in FIG. 2;

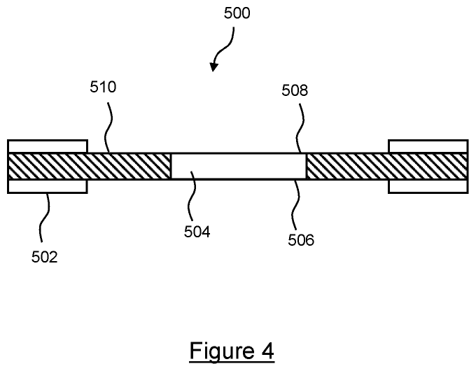

FIG. 4 shows schematically a cross-sectional view of an example of a piezoelectric component in accordance with and embodiment of the invention;

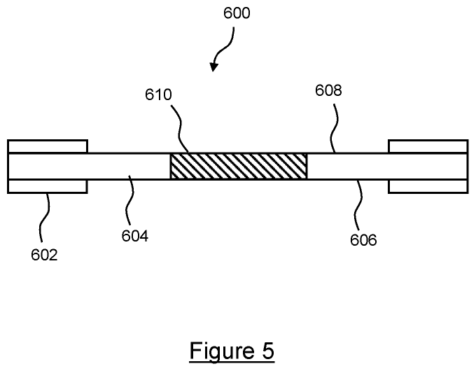

FIG. 5 shows schematically a cross-sectional view of an example of a piezoelectric component in accordance with and embodiment of the invention; and

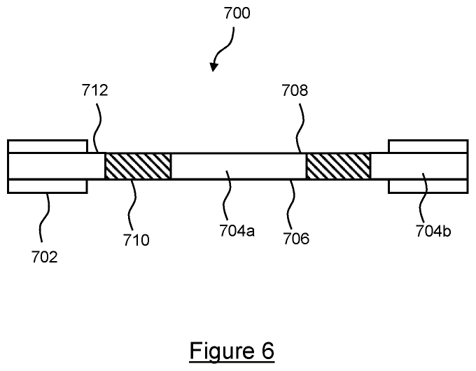

FIG. 6 shows schematically a cross-sectional view of an example of a piezoelectric component in accordance with and embodiment of the invention.

The example of FIG. 1 shows a piezoelectric component 100.

The piezoelectric component 100 includes a plurality of actuators 102. For example, in FIG. 1, the piezoelectric component 100 includes two ring-shaped actuators 102. In this example, each actuator 102 is a piezo actuator. In other examples, each actuator 102 may be another type of actuator such as a magnetostrictive actuator or a electrostrictive actuator.

The piezoelectric component 100 also includes a porous element 104. In this example, the porous element 104 is a porous membrane sandwiched between the two actuators 102. The porous element 104 has a plurality of pores. The plurality of pores extend through the porous element 104, from an inlet side 106 to an outlet side 108. In this example, the plurality of pores have an average diameter of less than or equal to 10 micrometres. The porous element 104 has a metal coating. In this example, the porous element 104 has a nickel coating.

The piezoelectric component 100 is assembled by forming a porous element 104 then attaching the plurality of actuators 102 to the porous element 104. In this example, the porous element 104 is a freeze-cast porous element formed as a single piece by a freeze-cast process.

In this example, the porous element 104 is prepared by:
Preparing a slurry by mixing aluminium oxide with liquid camphene;
Heating the slurry to 40 degrees Celsius to form a warmed slurry;
Heating a mould to 40 degrees Celsius;
Pouring the warmed slurry into the mould; and
Placing the mould on a block of ice having a temperature of minus 25 degrees Celsius for a period of 15 minutes so that the slurry freezes and the temperature of the slurry decreases to minus 20 degrees Celsius.

The example of FIG. 2 shows an aerosol-generating article 200. In this example, the aerosol-generating article 200 is a cartridge. The aerosol-generating article 200 includes a vaporiser for aerosolising a liquid aerosol-forming substrate. In this example, the vaporiser is the piezoelectric component 100 shown in FIG. 1 and described above.

The aerosol-generating article 200 has a housing 202. The housing 202 contains a liquid storage portion 204. In this example, a liquid aerosol-forming substrate 206 is stored in the liquid storage portion 204. The aerosol-generating article 200 has a transport body 208 for conveying the liquid aerosol-forming substrate 206 from the liquid storage portion 204 to the piezoelectric component 100. The transport body 208 contains a porous material and is soaked in the liquid aerosol-forming substrate 206. The transport body 208 has a first portion 210 and a second portion 212. The first portion 210 extends into the liquid storage portion 204. The second portion 212 is adjacent the piezoelectric component 100.

The liquid storage portion 204 has an opening 214 through which the liquid aerosol-forming substrate 206 can be conveyed to the piezo electric component 100. In this example, the porous element 104 extends across the opening 214.

The example of FIG. 3 shows an aerosol-generating system 300. The aerosol-generating system includes an aerosol-generating device 400 and the aerosol-generating article 200 shown in FIG. 2. FIG. 3 only shows part of the aerosol-generating device 400.

In this example, the aerosol-generating article 200 is disposed in an inverted position in the aerosol-generating device 400. In another example, the aerosol-generating article 200 may be disposed in the same orientation as the aerosol-generating device 400.

The aerosol-generating device 400 has a body 402. In this example, the body 402 is shaped to define a mouthpiece 404. The body 402 houses a power source. In this example, the power source is a rechargeable battery (not shown). The body 402 also houses a controller 406, which is shown schematically in FIG. 3. The body 402 also houses electrical connectors (not shown). The electrical connectors provide an electrical connection between the aerosol-generating device 400 and the aerosol-generating article 200.

The body 402 has a plurality of air inlets (not shown) that allow for air 408 to flow towards and over the piezoelectric component 100.

In use, a user puffs on the mouthpiece 404, which draws air 408 into the aerosol-generating device 400. In response to the user puffing on the mouthpiece 404, the controller 406 activates the piezoelectric component 100. When the piezoelectric component 100 activates, the actuator 102 vibrates the porous element 104. Vibrations in the porous element 104 deform the porous element 104 and deform the pores within the porous element 104. Liquid aerosol-forming substrate 206 flows from the liquid storage portion 204 through the opening 214 and to the inlet side 106 of the porous element 104 via capillary action through the transport body 208. The vibrations draw the liquid aerosol-forming substrate 206 into the pores within the porous element 104 and eject droplets of the liquid aerosol-forming substrate 206 from the outlet side 108, thereby aerosolising the liquid aerosol-forming substrate 206 into an aerosol 410. The aerosol 410 is drawn, by the user's puffing action, towards the mouthpiece 404. The flow of aerosol 410 through the aerosol-generating device 400 and towards the mouthpiece 404 is shown by 412. The aerosol 410 flows out of the mouthpiece 404 and is inhaled by the user.

FIG. 4 shows an example of a piezoelectric component 500 having a different arrangement to the piezoelectric component 100 shown in FIG. 1.

In the example of FIG. 4, the piezoelectric component 500 includes a plurality of actuators 502. For example, in FIG. 4, the piezoelectric component 500 includes two ring-shaped actuators 502. In this example, each actuator 502 is a piezo actuator.

The piezoelectric component 500 also includes a porous element 504. In this example, the porous element 504 is a porous membrane. The porous element 504 has a plurality of pores. The plurality of pores extend through the porous element 504, from an inlet side 506 to an outlet side 508. In this example, the plurality of pores have an average diameter of less than or equal to 10 micrometres.

The piezoelectric component 500 also includes a non-porous element 510. In this example, the non-porous element 510 is a metal ring-shaped element sandwiched between the two actuators 502.

The piezoelectric component 500 of FIG. 4 is assembled by: 1) forming the porous element 504; 2) forming the non-porous element 510; 3) attaching the non-porous element 510 to the plurality of actuators 502; and 4) attaching the porous element 504 to the non-porous element 510.

In this example, the porous element 504 is a freeze-cast porous element formed as a single piece by a freeze-cast process.

One advantage of the piezoelectric component 500 shown in FIG. 4 may be that the diameter of the porous element 504 can be controlled during the manufacturing process so as to allow control the aerosol that can be produced by the piezoelectric component 500. For example, the direction and volume of the aerosol can be controlled by changing the diameter of the porous element 504 because aerosol generation is restricted to the area of the porous element 504.

Another advantage is that the piezoelectric component of FIG. 4 may be easy to manufacture because the actuators 502 are not attached directly to the porous element 504, but instead to the non-porous element 510. Attaching the actuators 502 directly to the porous element 504 may require a special type of glue, which may increase the cost and complexity of the manufacturing process.

FIG. 5 shows an example of a piezoelectric component 600 having a different arrangement to the piezoelectric component 100 shown in FIG. 1.

In the example of FIG. 5, the piezoelectric component 600 includes a plurality of actuators 602. For example, in FIG. 5, the piezoelectric component 600 includes two ring-shaped actuators 602. In this example, each actuator 602 is a piezo actuator.

The piezoelectric component 600 also includes a porous element 604. In this example, the porous element 604 is a ring-shaped porous membrane. The porous element 604 is sandwiched between the two actuators 602. The porous element 604 has a plurality of pores. The plurality of pores extend through the porous element 604, from an inlet side 606 to an outlet side 608. In this example, the plurality of pores have an average diameter of less than or equal to 10 micrometres.

The piezoelectric component 600 also includes a non-porous element 610. In this example, the non-porous element 610 is a metal disc-shaped element attached to the centre of the porous element 604.

The piezoelectric component 600 of FIG. 5 is assembled by: 1) forming the porous element 604; 2) forming the non-porous element 610; 3) attaching porous element 604 to the plurality of actuators 602; and 4) attaching the non-porous element 610 to the porous element 604.

In this example, the porous element 600 is a freeze-cast porous element formed as a single piece by a freeze-cast process.

One advantage of the piezoelectric component 600 shown in FIG. 5 may be that the shape of the porous element 604 can be controlled during the manufacturing process so as to allow for control of the aerosol that can be produced by the piezoelectric component 600. For example, the direction and volume of the aerosol can be controlled because aerosol generation is restricted to the area of the porous element 604.

FIG. 6 shows an example of a piezoelectric component 700 having a different arrangement to the piezoelectric component 100 shown in FIG. 1.

In the example of FIG. 6, the piezoelectric component 700 includes a plurality of actuators 702. For example, in FIG. 6, the piezoelectric component 700 includes two ring-shaped actuators 702. In this example, each actuator 702 is a piezo actuator.

The piezoelectric component 700 also includes a plurality of porous elements 704. In this example, the piezoelectric component 700 includes a first porous element 704a and a second porous element 704b. Each porous element 704a, 704b is a ring-shaped porous membrane. Each porous element 704a, 704b has a plurality of pores. The plurality of pores extend through the porous element 704a, 704b, from an inlet side 706 to an outlet side 708. In this example, the plurality of pores have an average diameter of less than or equal to 10 micrometres.

The piezoelectric component 700 also includes a non-porous element 710. In this example, the non-porous element 710 is a metal ring-shaped element.

In the example of FIG. 6, the first porous element 704a is a disc-shaped element attached to the centre of the ring-shaped non-porous element 710. In the example of FIG. 6, the second porous element 704b is sandwiched between the two actuators 702, and attached to an outer surface of the non-porous element 710.

The piezoelectric component 700 of FIG. 6 is assembled by: 1) forming the first porous element 704a and the second porous element 704b; 2) forming the non-porous element 710; 3) attaching first porous element 704a to the plurality of actuators 702; 4) attaching the non-porous element 710 to the first porous element 704a; and 5) attaching the second porous element 704b to the non-porous element 710.

In this example, both the first porous element 704a and the second porous element 704b are freeze-cast porous elements, each formed as a single piece by a freeze-cast process.

One advantage of the piezoelectric component 700 shown in FIG. 6 may be that the shape of the porous elements 704a, 704b can be controlled during the manufacturing process so as to allow for control of the aerosol that can be produced by the piezoelectric component 700. For example, the direction and volume of the aerosol can be controlled because aerosol generation is restricted to the area of the porous elements 704a, 704b.

For the purpose of the present description and of the claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A ±5% of A. Within this context, a number A may be considered to include numerical values that are within general standard error for the measurement of the property that the number A modifies. The number A, in some instances as used in the claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1.-7. (canceled)

8. An aerosol-generating article, comprising:
an atomiser configured to atomise a liquid aerosol-forming substrate to generate an aerosol, the atomiser comprising:
a piezoelectric component comprising:
an actuator; and
a porous element,
wherein the actuator is arranged to vibrate the porous element to generate an aerosol, and
wherein the porous element is a freeze-cast porous element.

9. The aerosol-generating article according to claim 8, wherein the piezoelectric component further comprises a non-porous element attached to the porous element.

10. The aerosol-generating article according to claim 8, wherein the porous element comprises pores that have a diameter of less than or equal to 30 micrometres.

11. The aerosol-generating article according to claim 10, wherein the porous element comprises pores that have a diameter of at least 10 micrometres.

12. The aerosol-generating article according to claim 8, wherein the porous element comprises a metal coating.

13. The aerosol-generating article according to claim 12, wherein the porous element further comprises a nickel coating.

14. An aerosol-generating system, comprising:
an aerosol-generating device; and
the aerosol-generating article according to claim 8.
